(19) United States
(12) Patent Application Publication
(10) Pub. No.: US 2019/0008128 A1
(43) Pub. Date: Jan. 10, 2019

(54) FISHING LURE WITH INTERCHANGEABLE BODY AND HEAD SEGMENTS

(71) Applicant: Justice Tackle & Co., LLC, Jupter, FL (US)

(72) Inventor: Christopher Walsh, Jupiter, FL (US)

(21) Appl. No.: 16/031,570

(22) Filed: Jul. 10, 2018

Related U.S. Application Data
(60) Provisional application No. 62/530,712, filed on Jul. 10, 2017.

(51) Int. Cl. A01K 85/18

(52) U.S. Cl. CPC A01K 85/18

(57) ABSTRACT

A fishing lure having interchangeable segments. The fishing lure contains a head portion having a first component of a head-to-body locking unit and a body portion having a second component of a head-to-body locking unit. When locked together, the fishing lure is configured to replicate an intact sea creature or animal.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 62/530,712 entitled “FISHING LURE WITH INTERCHANGEABLE BODY AND HEAD SEGMENTS” filed Jul. 10, 2017. The contents of the above referenced application are incorporated herein by reference in its entirety.

### FIELD OF THE INVENTION

The present invention relates to fishing devices, and more particularly, to a fishing lure having interchangeable head and body segments which are configured to replicate an intact sea creature or animal.

### BACKGROUND OF THE INVENTION

Fishing dates back to the Paleolithic period. Since that time, fish have been caught for commercial and recreational purposes. A universally accepted method of catching fish is commonly referred to as angling, wherein a rod and reel combination is used for tethering a fish hook at the end of fishing line. While the use of a rod and reel combination is commonplace, countless types of lures have been secured to the end of a fishing line in order to entice a fish to take the bait. While the lures can be of most any shape, size or material, all must include a hook for capturing a fish. While great care has been taken to conceal the hook, the fishing line, which must be secured to the lure, can scare away a fish despite the tempting lure. Present day fishing lines may be nylon, polyethylene, polyester, monofilament, multifilament, fluoro-carbon, stainless steel wire, or even braided elements, to name just a few. The type of fish sought determines the optimum fishing line and technique, such as trolling, deep drop, casting, and so forth. Larger fish require thicker diameter lines, which are easy to spot in the water. Fishing lines used for trolling are even more difficult to conceal as the lines must be large enough to handle pressures due to dragging of lures. Trolling is a type of fishing used to catch roaming fish. Trolling, whether near shore or offshore, is often the most productive method for catching a variety of blue water pelagic fish and near shore salt water fish. Unfortunately, many opportunities are lost due to the use of a fishing line that is easily detected the fish. Regardless of the technique used, use of a suitable fishing lure is critical in successfully catching fish.

### SUMMARY OF THE INVENTION

The present invention relates to a fishing lure having interchangeable head and body segments. When locked together, the fishing lure is configured to replicate an intact sea creature or animal. The fishing lure contains a head portion, having a first component of a head-to-body locking unit, is configured to receive and secure a second component of a head-to-body locking unit. The fishing lure further comprises a body portion having the second component of a head-to-body locking unit. The second portion of the head-to-body locking unit is configured to engage with the first component of a head-to-body locking unit. Rotation of the second component of a head-to-body locking unit causes the second component to be locked in place within the first component of a head-to-body locking unit, thereby locking the head portion to the body portion.

In one illustrative embodiment, the fishing lure having interchangeable segments comprises a first segment having a first end, a second end, and main body therebetween, the first segment having a first component of a head-to-body locking unit; and a second segment having a first end, a second end, and a main body therebetween, the second segment having a second component of said head-to-body locking unit. The first segment is configured to secure together with the second segment to form a body that replicates a sea creature or animal. The first component of a head-to-body locking unit may comprise a first channel sized and shaped to receive at least one portion of the second component of the head-to-body locking unit when in an insertion orientation, and a second channel sized and shaped to secure to at least one portion of the second component of the head-to-body locking unit when in the locked position. The first component first channel and the first component second channel may be arranged at different orientations within the first segment, thereby providing a slide and/or rotate locking mechanism.

Accordingly, it is an objective of the instant invention to teach a fishing lure having interchangeable head and body segments which are configured to replicate an intact sea creature or animal.

It is a further objective of the invention to teach a fishing lure having interchangeable head and body segments configured to replicate an intact sea creature or animal in which the head portion engages with and locks with a body portion using a linear motion.

It is yet another objective of the invention to teach a fishing lure having interchangeable head and body segments configured to replicate an intact sea creature or animal in which the head portion engages with and locks with a body portion using a rotational motion.

It is a still further objective of the invention to teach a fishing lure having interchangeable head and body segments configured to replicate an intact sea creature or animal in which the head portion engages with and locks with a body portion using a linear motion and a rotational motion.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a perspective view of an illustrative embodiment of a fishing lure having securable segments;

FIG. 2 is a perspective view of the fishing lure illustrated in FIG. 1, with a head portion removed from a body portion;

FIG. 3A is a perspective view of the head portion of the fishing lure;

FIG. 3B is a cross sectional view of the head portion taken along lines 3B-3B of FIG. 3A;

FIG. 4 is a back end view of the head portion of the fishing lure;

FIG. 5A is a perspective view of an illustrative embodiment of a swim characteristic manipulating member;

FIG. 5B is an alternative embodiment of the swim characteristic manipulating member;

FIG. 5C illustrates an initial insertion of the swim characteristic manipulating member into the head portion of the fishing lure;

FIG. 5D illustrates the swim characteristic manipulating member inserted into the head portion of the fishing lure;

FIG. 5E is a cross sectional view of the head portion as shown in FIG. 3B, illustrating full insertion of the swim characteristic manipulating member;

FIG. 6 is a perspective view of the body portion of the fishing lure;

FIG. 7 is an alternative view of the body portion of the fishing lure;

FIG. 8 is a perspective view of the fishing lure, illustrating the main body prior to insertion into and engagement with the head portion;

FIG. 9 is a perspective view of the fishing lure with the body portion partially inserted into the head portion;

FIG. 10 is a perspective view of the fishing lure with the body portion fully inserted and locked to the head portion;

FIG. 11 is an alternative embodiment of the fishing lure, illustrating a fishing lure having a head portion and body portion configured to replicate a different fish species;

FIG. 12A is an alternative embodiment of the fishing lure, illustrating a fishing lure having a head and body portion configured to replicate a frog;

FIG. 12B illustrates the fishing lure shown in FIG. 12A in which the head portion is separated from the body portion; and

FIG. 13 illustrates multiple components of the fishing which form a kit, thereby providing the user with a fishing lure having a head portion and a body portion that can be interchangeably mixed and matched to provide the user with a fishing lure have different body shapes and functions;

FIG. 14 is a schematic representation of an illustrative embodiment of a chip-based sound generating unit;

FIG. 15 illustrates the fishing lure having a slide and lock mechanism.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

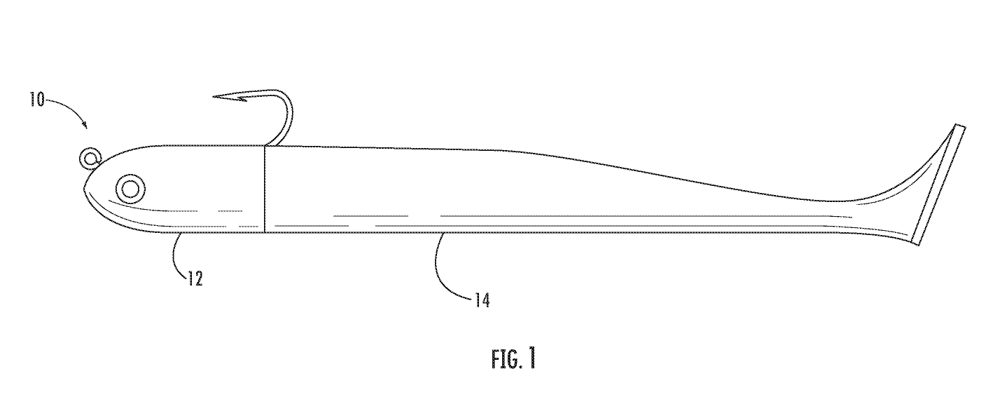

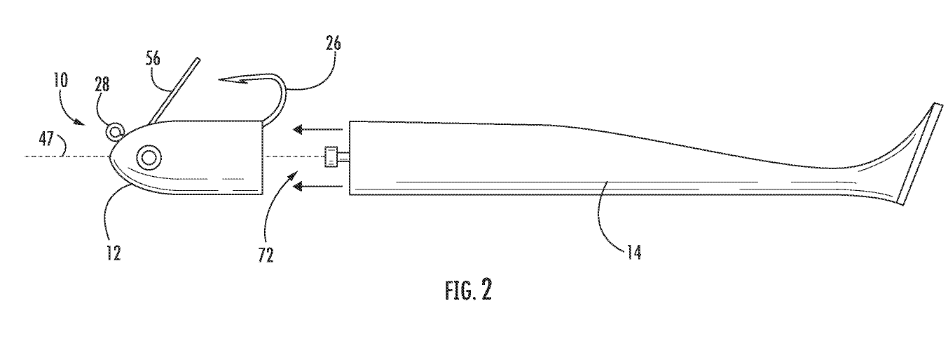

Referring to FIG. 1, an illustrative embodiment of a fishing lure having interchangeable segments, referred to as fishing lure 10, is shown. The fishing lure 10 is designed to attach or remove a first segment, illustrated herein as a head portion 12 to/from a second segment, illustrated herein as a body portion 14. The head portion 12 and the body portion 14 are configured to secure together to form a body that replicates a sea creature or animal, and can be used to attract fish. Accordingly, the fishing lure can be configured to resemble baitfish, mice, crayfish, insects, frogs, or other animals and/or objects that fish prey upon. FIG. 2 illustrates the head portion 12 separated from the body portion 14.

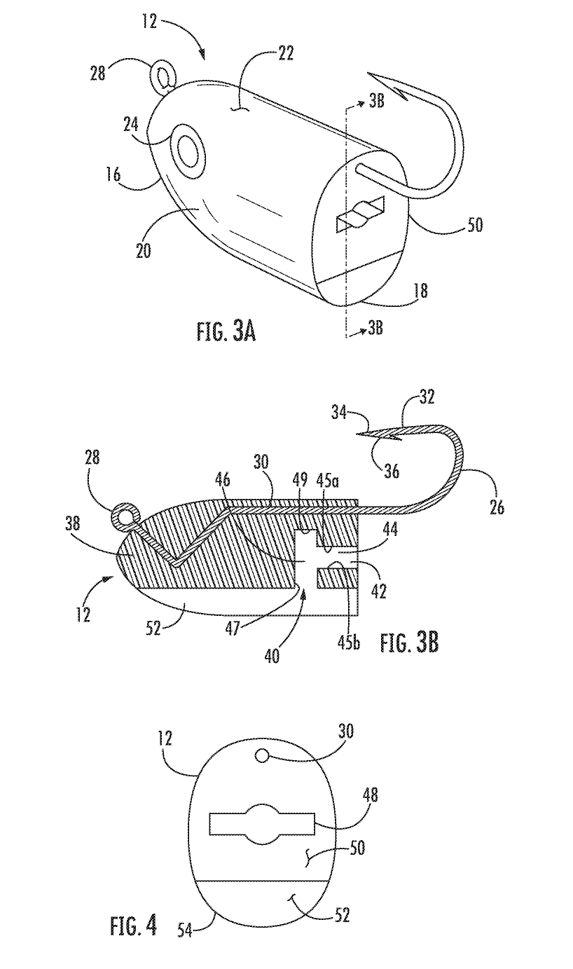

Referring to FIGS. 3A-4, the head portion 12 is shown. The head portion 12 may be sized and shaped to replicate the head region of, for example, baitfish, mice, crayfish, insects, frogs, or other animals and/or objects that fish prey upon. The head portion 12 comprises a first end 16, a second end 18, and a head portion body 20 extending between and separating the first end 16 and the second end 18. The head portion 12 has an outer surface 22 which may contain coloring or markings to replicate the sea creature or animal. An eye 24, which may be an actual structure or painted on replica of an animal eye, may be used. The head portion 12 may be made of any material(s) commonly used in the manufacturing of fishing lures, but is preferably made of a polymeric material such as plastic. Preferably, the head portion is made of a hard plastic, but a soft plastic material may be used as well.

To aid in capturing a fish, in which the fish actually bites at and contacts the fishing lure 10, a hook 26 is secured to the head portion 12. The hook is preferably a standard fishhook, having an eyelet 28, a shank 30 that extends within the head portion 12, a bight portion 32, and a pointed terminal end 34 with or without a barb 36. The hook 22 may be coated with a protective coating to prolong the useful life of the hook by providing protection from the adverse effects of the environment, such as rusting, corroding, or other weathering.

The interior region 38 of the head portion 12 houses a first component of a head-to-body locking unit, referred to generally as head-to-body locking unit first member 40. The head-to-body locking unit first member 40 is configured to receive and secure a second component of a head-to-body locking unit (to be described later). The head-to-body locking unit first member 40 comprises a head-to-body locking unit internal passageway 42 sized and shaped to allow passage of the second component of a head-to-body locking unit. The head-to-body locking unit internal passageway 42 may comprise two opposing guiding surfaces 45A and 45B. The two opposing guiding surfaces 45A and 45B may be sized and shaped to contour at least a portion of a second component of the head-to-body locking unit (see 72, to be described later).

The head-to-body locking unit internal passageway 42 comprises a first channel 44 and a second channel 46, the second channel 46 oriented in a direction that is different than the orientation of the first channel 44. The second channel 46 may be defined by a back surface 47 and at least one side surface 49 (see FIG. 3A). The first channel 44 is formed in a generally parallel orientation relative to the longitudinal axis 47 (see FIG. 2) of the head portion 12. The second channel 46 is orientated in a direction which is at an angle, preferably at a 90 degree angle or perpendicular from the first channel 44 or the longitudinal axis 47. In this orientation, the head-to-body locking unit internal passageway 42 may form a “T” shape. In any orientation, the head-to-body locking unit internal passageway 42 may be designed to allow the second component of a head-to-body locking unit to slide within the first channel 44 (when in the insertion orientation, i.e. when being inserted therein), preferably in a linear manner, and be rotated to engage or fit within the second channel 46, thereby locking in place (locked position).

The head-to-body locking unit internal passageway 42 may comprise a head-to-body locking unit internal passageway opening 48 cut out of the back surface 50 of the head portion 12. The head-to-body locking unit internal passageway opening is sized and shaped to allow the second component of the head-to-body locking unit to enter into the head-to-body locking unit internal passageway 42. While most of the interior region 38 of the head portion 12 may be solid, a duct 52 may run the entire or partial length of the head portion body 20. Opening 54 allows a user to place a material, such as a liquid scent, into the duct 52. Optionally, the head portion 12 may include a tube 56 extending away from the outer surface 22 which acts as a barrier should the fishing lure 10 be dragged in weeds.

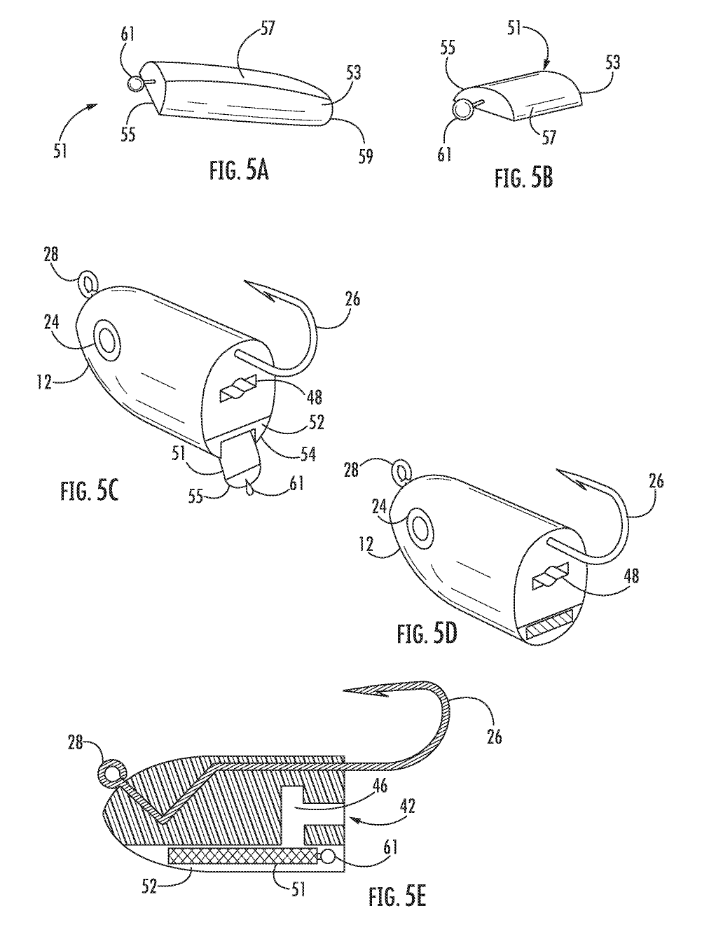

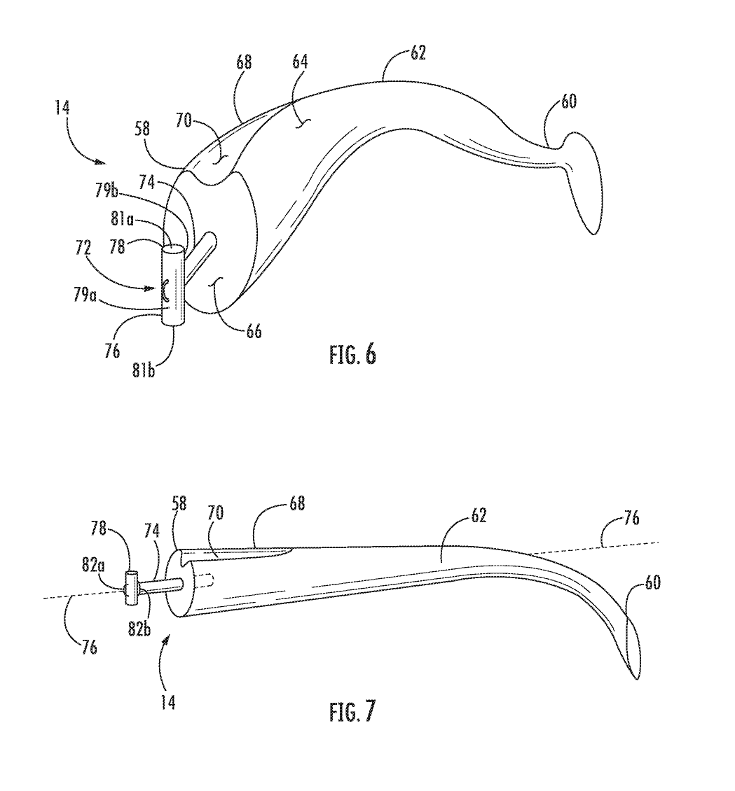

To aid in manipulating the swim characteristics associated with the fishing lure 10 as is moves, or is pulled through the water, the duct 52 may be sized and shaped to receive and hold a swim characteristic manipulating member 51, see FIGS. 5A and 5B. The swim characteristic manipulating member 51 contains a first end 53, a second end 55, and a main body 57. The main body 57 illustrated in FIG. 5A is elongated with a rounded edge 59 and may be constructed of a plastic or cork material. An eyelet 61 secured to the second end 55 aids in removing the swim characteristic manipulating member 51 from the fishing lure 10. The swim characteristic manipulating member 51 illustrated in FIG. 5B contains a differently shaped main body 57 as that illustrated in FIG. 5A, and may be made of a different material, such as lead. Accordingly, the swim characteristic manipulating member 51 may be, for example, a weight or a float member and, therefore, can be constructed of various materials, including, but not limited to, plastic, cork material, lead, a high-density material, or any buoyant material.

FIG. 5C illustrates the swim characteristic manipulating member 51 being inserted into the head portion 12 of the fishing lure 10. The first end 53 of the swim characteristic manipulating member 51 is inserted through opening 54 and positioned within duct 52. The swim characteristic manipulating member 51 is pushed further into the duct 52 so the main body 57 and eyelet 61 rest completely within the duct 52, see FIG. 5D and 5E. Insertion of the swim characteristic manipulating member 51 causes the fishing lure 10 to be pulled through the water and manipulated, or rotated, so that, for example, the hook 26 is positioned in an upward (directed toward the surface of the water) or downward (directed into or away form the surface of the water) orientation. Changing the material or density of the swim characteristic manipulating member 51 provides a mechanism to change the swim characteristics or orientation of the fishing lure 10 as it is pulled through the water, with heavier or high density materials, causing more movement or rotation.

Referring to FIGS. 6 and 7, an illustrative embodiment of the body portion 14 is shown. The body portion 14 comprises a first end 58, a second end 60, and an elongated body member 62 separating the first end 58 and the second end 60. The body portion 14 has an outer surface 64 which may contain coloring or markings to replicate the sea creature or animal. The body portion 14 may be made of any material(s) commonly used in the manufacturing of fishing lures, but is preferably made of a polymeric material such as plastic. Preferably, the body portion 14 is made of a soft or flexible plastic material, but a hard plastic material may be used as well. A front face surface is sized to have the same or similar shape as the back surface 50 of the head portion 12 so that, when the head portion 12 and the body portion 14 are aligned, they are flush together. The upper edge 68 contains a channel 70 cut into the elongated body member 62; the channel 70 being sized and shaped to allow at least a portion of the hook 26 to rest inside when the head portion 12 is fully engaged and locked with the body portion 14.

Extending outwardly and away from the front face surface 66 is the second component of the head-to-body locking unit, referred to generally as the head-to-body locking unit second member 72. The head-to-body locking unit second member comprises a first elongated member, illustrated as a generally cylindrical body 74, extending out from the front face surface 66. A portion of the cylindrical body 74 is secured within the elongated body member 62 of the body portion 14. The cylindrical body 74 is oriented in a direction that is parallel to the longitudinal axis 76 of the main body 14. The head-to-body locking unit second member 72 comprises a second elongated member, illustrated herein as an elongated, generally rectangular body 78. The rectangular body 78 is secured to, or integrally formed from, the cylindrical body 74 and orientated in a direction which is at an angle, preferably at a 90 degree angle or perpendicular, from the cylindrical body 74 or the body longitudinal axis 76.

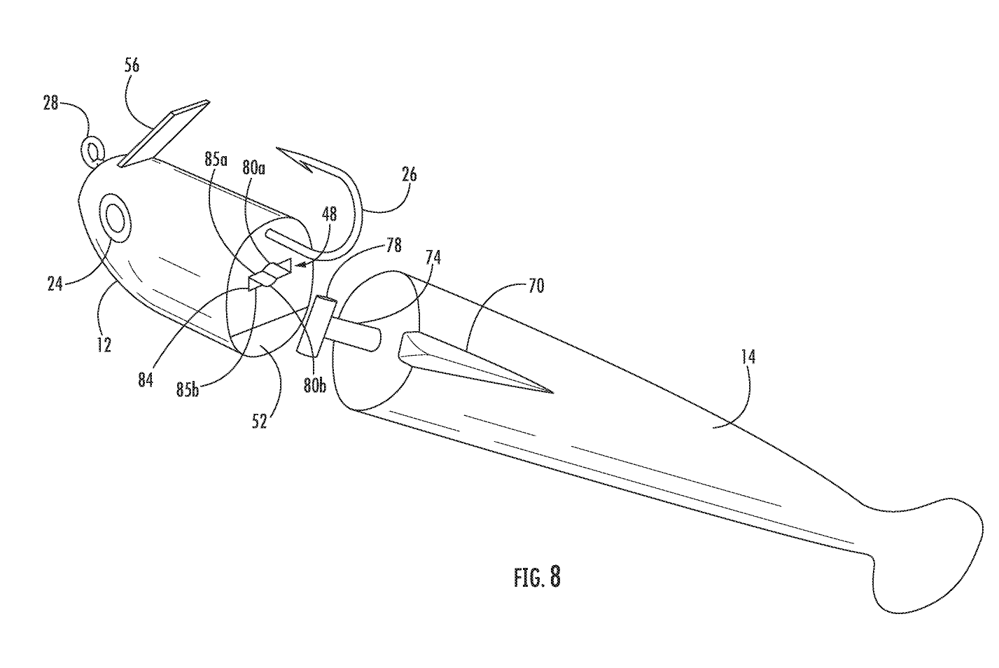

FIGS. 8-10 illustrate the securing of the head portion 12 to the body portion 14. In FIG. 8, the head portion 12 is separated from the body portion 14. To secure the head portion 12 to the body portion 14, the body portion 14 is positioned so that the head-to-body locking unit second member is inserted into the head-to-body locking unit internal passageway opening 48. As illustrated, the head-to-body locking unit internal passageway opening 48 is sized and shaped to receive the head-to-body locking unit second member 72. The head-to-body locking unit internal passageway opening 48 contains two partially curved surfaces 80A and 80B having a curvature to match the curved side surfaces 82A and 82B of the cylindrical body 74 (see FIG. 7) and a generally rectangular shape 84 to match the rectangular shape of the elongated rectangular body 78. The rectangular shape of the elongated rectangular body 78 may further be defined by a first or front surface 79A, a second or back surface 79B, a third or top surface 81A, and a fourth or bottom surface 81B. The first front surface 79A may be in contact with the second channel 46 back surface 47 when locked in place. The generally rectangular shape 84 may comprise an upper surface 85A and a lower surface 85B. This provides a mechanism to guide the head-to-body locking unit second member 72 as it moves and travels within the head-to-body locking unit internal passageway opening 48 and head-to-body locking unit internal passageway 42.

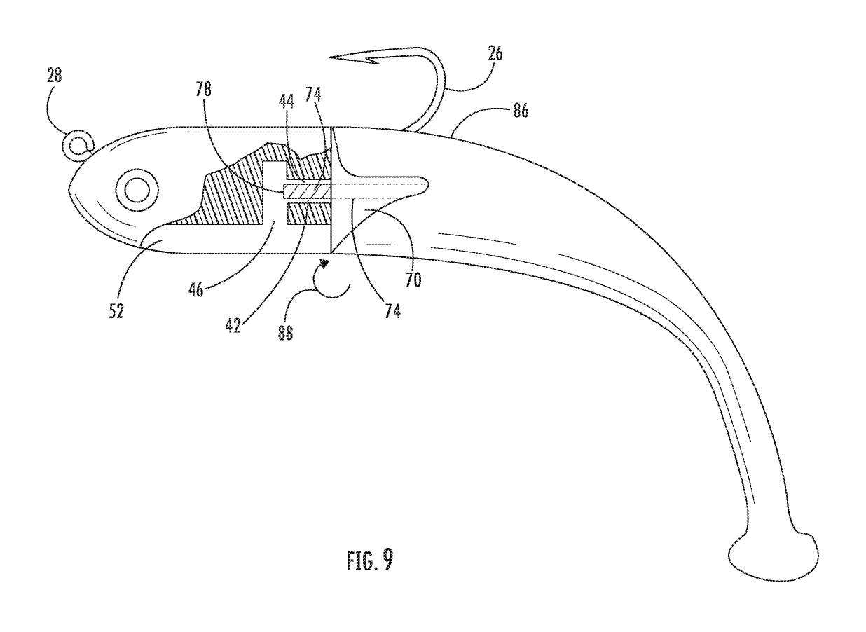

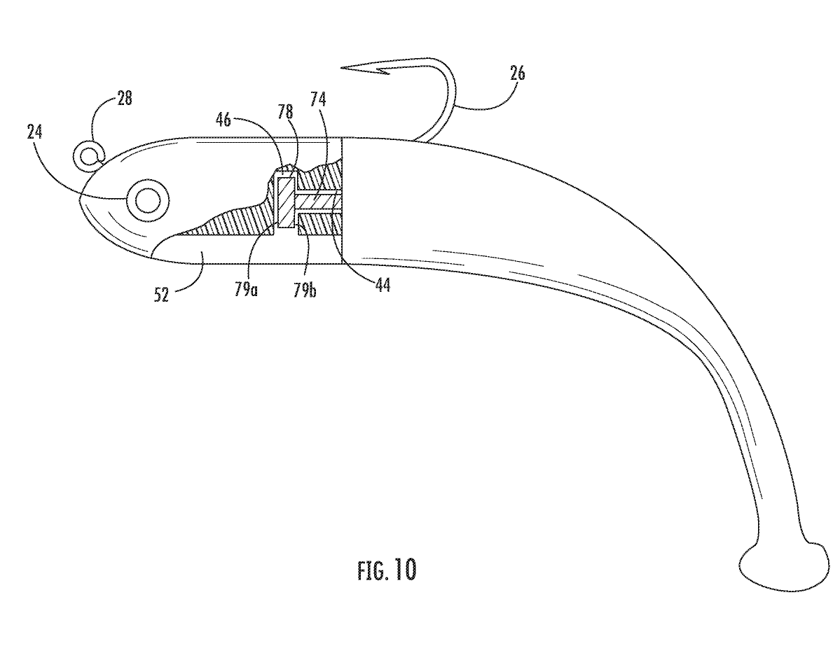

Drawing the body portion 14 to the head portion 12 so the front face surface 66 abuts with the back surface 50 of the head portion 12 allows at least a portion of the cylindrical body 74 to move within, in a linear direction, the first channel 44 of the head-to-body locking unit internal passageway 42, see FIG. 9. In this position, a side portion 86 of the body portion 14 rests just under the hook 26. To fully engage the head portion 12 with the body portion 14, thereby locking in place, the head-to-body locking unit second member 72 is inserted deeper into the head-to-body locking unit internal passageway 42 so that the elongated rectangular body 78 extends past the first channel 44 and into the second channel 46. To lock in place, the main body is rotated, thereby rotating the elongated rectangular body 78 to align with the orientation of the second channel 46, see FIG. 10. To obtain this position, the body 14 must be rotated in the correct direction. As illustrated in FIG. 9, rotation in the direction of arrow 88, i.e. towards the hook 26, allows the channel 70 to fit under the hook 26. Should the body 14 have to be turned in a direction away from the hook 26, a portion of the body 14 would rest against the hook 26 and prevent rotation.

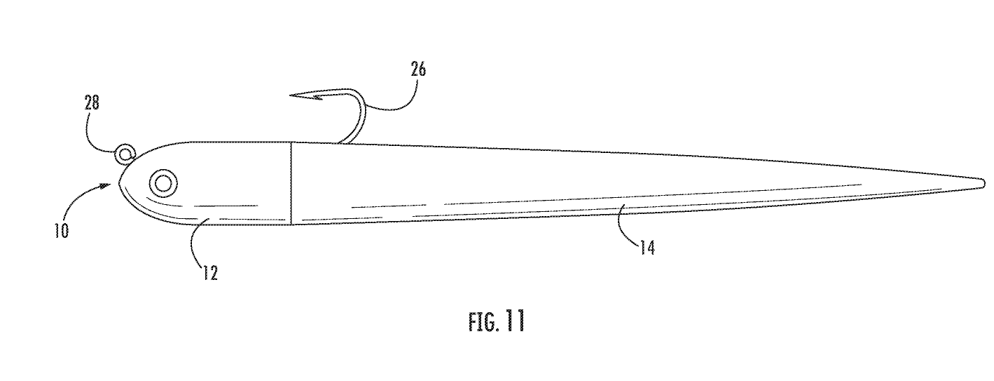

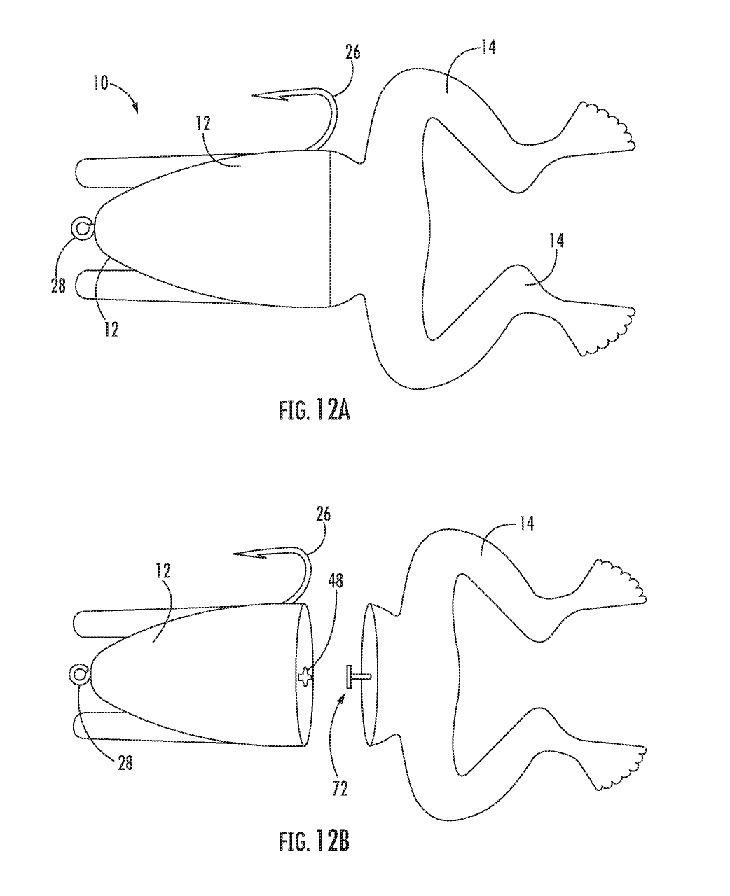

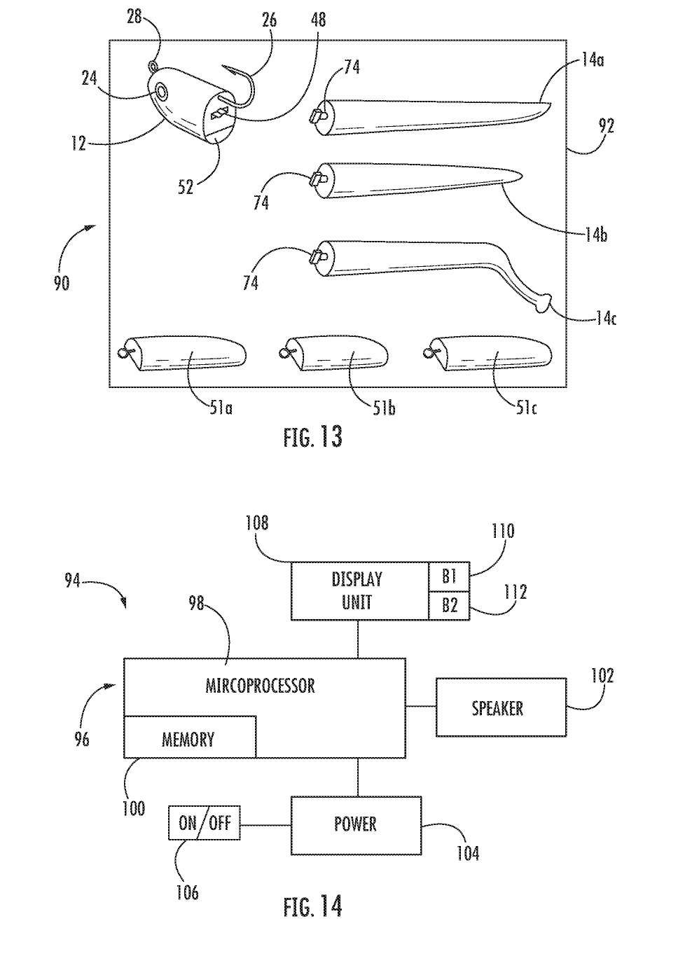

FIGS. 11-12B illustrate embodiments of the fishing lure 10 which replicate different sea creatures or animals. Each fishing lure 10 shown contains the same features as described in FIGS. 1-10. The fishing lure 10 illustrated in FIG. 11 shows a baitfish having a different body shape than illustrated in FIGS. 1-10. FIGS. 12A and 12B illustrate a fishing lure having the body of a frog. FIG. 12A illustrates the fishing lure with the head portion 14 secured to the body portion 12. FIG. 12B illustrates the head portion 12 separated from the body portion 14, exposing the head-to-body locking unit second member 72.

FIG. 13 illustrates a kit 90 containing one or more components of the fishing lure 10. As illustrated, the kit 90 contains a housing 92, which may be a bag or a plastic box, having one or more head portions 12, one or more body portions (collectively referred to as 14, individually as 14A, 14B, and 14C), and one or more swim characteristic manipulating members 51 (collectively referred to as 51, individually as 51A, 51B, and 51C). Kit 90 provides a mechanism to allow a user to have a fishing lure that can assume different bodies and/or different swim characteristics. As illustrated, the head portion 12 may be secured to body portion 14 having different shapes or sizes (or colors) to represent different bait fish or sea creatures, (illustrated by 14A, 14B, or 14C). The swim characteristics can also be manipulated as required by the type of fish the user is seeking by interchanging one or more swim characteristic manipulating members 51 so that they are different sizes, shapes, or constructed of different materials (51A, 51B, and 51C being made of different materials, such as plastic, lead, or cork).

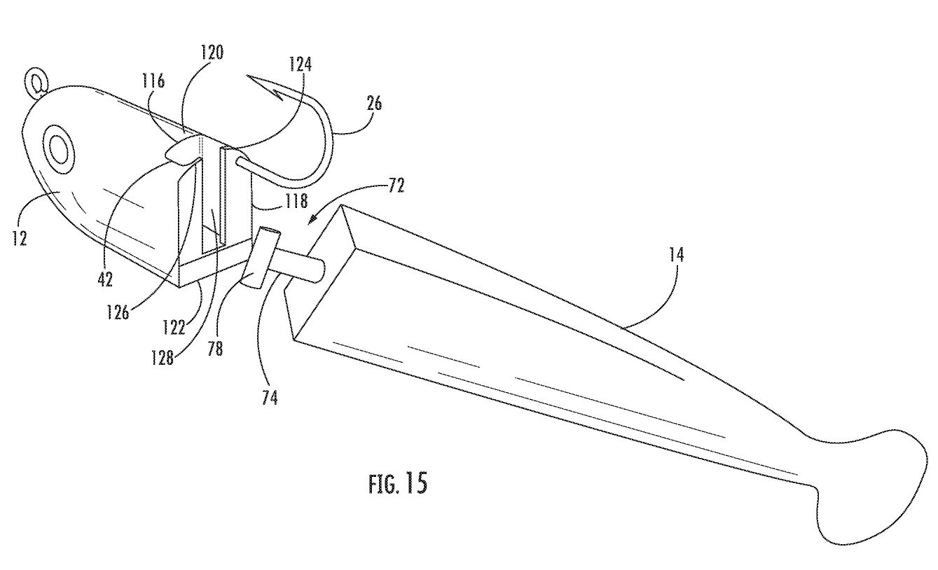

To aid in capturing a fish, or other sea creature or animal, the fishing lure 10 may be configured to emit one or more frequencies, vibrations, or sounds that replicate one or more types of natural sound(s) made by the fish in the wild. Such sounds may be, for example, frequencies, vibrations, or sounds associated with feeding fish, struggling fish, frenzied fish, or any other fish activities for which frequencies, vibrations, or sounds can be generated. Accordingly, the fishing lure 10 may be configured to emit one or more sounds associated with a single fish species, i.e. grouper, or one or more sounds associated with two or more different fish species, i.e. grouper, snapper, tuna, and trout. The fishing lure 10 may also be configured to emit one or more frequencies, vibrations, or sounds that replicate one or more types of natural sound(s) made by a single sea creature or animal species or one or more sounds associated with two or more different sea creatures or animal species. The head portion 12, the body portion 14, or the head portion 12 and the body portion 14 of the fishing lure 10 may contain a sound generating unit 94. FIG. 14 illustrates an example of a chip-based sound generating unit 94 which may generate or have the one or more frequencies, vibrations, or sounds stored therein. The chip-based sound generating unit 94 comprises an integrated chip (IC) 96 having a microprocessor 98 with memory 100 to control the electrical operation of generating or emitting the one or more frequencies, vibrations, or sounds as described above via speaker 102. The memory 100 may be, for example, read only memory, ROM, random access memory, RAM, or any other type of memory known to one of skill in the art. The microprocessor 98 and other components may be powered by a power source, 104, such as a battery. The electrical operation of generating or emitting the one or more frequencies, vibrations, or sounds (which may be stored in memory 100) may be controlled by an on/off button 106 prior to insertion of the fishing lure 10 into the water. Alternatively, the generating or emitting of the one or more frequencies, vibrations, or sounds may be controlled by other mechanisms known to one of skill in the art. The chip-based sound generating unit 94 may optionally include a display unit 108, such as an LED display located within the head portion 12, or the body portion 14, that can display the modes of action, such as the one or more frequencies, vibrations, or sounds, or can be used to modify the modes of action. Such modifications to the modes of action, i.e. changing the one or more frequencies, vibrations, or sounds, may be accomplished via buttons, button one, 110, or button two, 112. Alternatively, the display unit 108 may be configured as a touch screen device.

Referring to FIG. 15, the fishing lure 10 is shown with the head portion 12 slideably engaging with the body portion 14. In this embodiment, the head-to-body locking unit internal passageway 42 has a shaped opening 116 and an internal channel 118 that runs from a top surface 120 towards a bottom surface 122, in a generally vertical orientation. The head-to-body locking unit internal passageway 42 illustrated in FIG. 15 is configurated to receive and secure with the head-to-body locking unit second member 72. In this embodiment, the elongated, generally rectangular body 78 of the head-to-body locking unit second member 72 is sized and shaped, in this illustration as a rounded surface, to cooperate with the size and shape of internal channel 118. The edges 124 and 126 maintain the position of the rectangular body 78 when it is inserted within the internal channel 118. A side opening 128 allows the head-to-body locking unit second member cylindrical body 74 to slide therein when the head portion 12 slideably engages with the body portion 14.

All patents and publications mentioned in this specification are indicative of the levels of those skilled in the art to which the invention pertains.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fishing lure having interchangeable segments comprising:
a first segment having a first end, a second end, and a main body therebetween, said first segment having a first component of a head-to-body locking unit; and
a second segment having a first end, a second end, and a main body therebetween, said second segment having a second component of said head-to-body locking unit;
said first segment is configured to secure together with said second segment to form a body that replicates a sea creature or animal.

2. The fishing lure having interchangeable segments according to claim 1, wherein said first component of a head-to-body locking unit comprises a first channel sized and shaped to receive at least one portion of said second component of the head-to-body locking unit when in an insertion orientation, and a second channel sized and shaped to secure to at least one portion of said second component of the head-to-body locking unit when in the locked position.

3. The fishing lure having interchangeable segments according to claim 2, wherein said first component first channel and said first component second channel are arranged at different orientations within said first segment.

4. The fishing lure having interchangeable segments according to claim 2, wherein said second component of said head-to-body locking unit extends outwardly and away from a front face surface of said second segment first end and is sized and shaped to slideably and rotatably engage with said head-to-body locking unit first component.

5. The fishing lure having interchangeable segments according to claim 1, wherein first segment is configured to have a shape or appearance of at least a head of said sea creature or animal.

6. The fishing lure having interchangeable segments according to claim 1, wherein said second segment is configured to have at least a shape or appearance of a body of said sea creature or animal.

7. The fishing lure having interchangeable segments according to claim 6, wherein said sea creature is a fish.

8. The fishing lure having interchangeable segments according to claim 1, wherein said head portion or said body portion has an outer surface which may contain coloring or markings to replicate said sea creature or animal.

9. The fishing lure having interchangeable segments according to claim 1, wherein said first segment is made of a hard or soft plastic material.

10. The fishing lure having interchangeable segments according to claim 1, wherein said second segment is made of a hard or soft plastic material.

11. The fishing lure having interchangeable segments according to claim 1, further comprising a fishhook.

12. The fishing lure having interchangeable segments according to claim 1, further including a swim characteristic manipulating member.

13. The fishing lure having interchangeable segments according to claim 12, wherein said swim characteristic manipulating member is a weighted object secured within a duct within said first segment.

14. The fishing lure having interchangeable segments according to claim 1, further including liquid stored within said first segment.

15. The fishing lure having interchangeable segments according to claim 1, wherein said first segment or said second segment includes a sound generating unit.

16. The fishing lure having interchangeable segments according to claim 15, wherein said sound generating unit includes a speaker for emitting one or more frequencies, vibrations, or sounds associated with one or more sea creatures or sea creature species.
